(19) United States
(12) Patent Application Publication
(10) Pub. No.: US 2020/0317874 A1
(43) Pub. Date: Oct. 8, 2020

(54) Heat Shrinking Polyester Film

(71) Applicant: Anheuser-Busch InBev S.A., Brussels (BE)

(72) Inventor: Daniel Peirsman, Leuven (BE)

(21) Appl. No.: 16/768,771

(22) PCT Filed: Nov. 27, 2018
(86) PCT No.: PCT/EP2018/082678

§ 371 Date: Jun. 1, 2020

(30) Foreign Application Priority Data
Dec. 1, 2017 (BE) 2017/5887

(51) Int. Cl. C08J 5/18

(52) U.S. Cl. CPC C08J 5/18; C08J 2367/02; C08J 2367/06

(57) ABSTRACT

The present invention discloses a method for preparation of a heat shrinking polyester film. The method includes obtaining a polyester film made from a modified composition of a polyester. The composition of polyester include one or more polyester selected from but not limited to group consisting of terephthalic acid (PET), naphthalenedicarboxylic acid (PEN), 1,4-cyclohexane-di-carboxylic acid, Polybutylene terephthalate (PBT), Polytrimethylene terephthalate (PTT) and isophthalic acid. The composition further includes an amount of Maleic anhydride as a cross linking agent, and optionally an amount of glycol. The method further includes thermally stretching the obtained polyester film in a stretching direction under a predetermined direction under a predetermined reduced temperature. Thereafter, the polyester film is cooled thereby locking the shrink properties within the polyester film.

The present disclosure generally relates to a shrink film and more particularly relates to a method of preparing a heat shrinking polyester film.

### BACKGROUND TO THE INVENTION

Shrink films, also referred to as heat-shrinking films, are widely used in various packaging applications within the packaging industry. Recently, there has been a significant rise in the demand for shrink films, generally, as well as for shrink films with high tensile strength and stretching properties. Such films are capable of shrinking upon application of heat to release stress imparted to the film during or subsequent to extrusion. The shrinkage can occur in one direction or in both longitudinal and transverse directions. This process causes the film to shrink around the product producing a tight, transparent wrapping that conforms to the contour of the product and which is aesthetically pleasing. This further providing the useful functions required of packaging materials such as protection of the product from loss of components, pilferage, or damage due to handling and shipment. Typical items wrapped in shrink films are toys, games, sporting goods, stationery, greeting cards, hardware and household products, office supplies and forms, foods, phonograph records, and industrial parts.

Traditionally, polymer materials such as polyolefin and polyvinyl chloride has been generally used in production of most of the commercially available shrink films. Such films however, inherits less desirable mechanical properties, such as tensile strength and modulus, and therefore packaging of these films are more apt to tear or otherwise become physically damaged during handling. As well, they generally do not possess high temperature heat resistance, which limits their application for cook-in uses. Further, such materials are not easily recyclable, therefore causes significant environmental hazard. Specifically, PVC on thermal decomposition produces a medical profession recognized carcinogen-dioxin, and therefore, some European countries have started to ban the use of PVC materials, especially for packaging of food and medicines.

Other materials considered for production include various polyesters such as Polyethylene terephthalate (polyethylene terephthalate, abbreviated PET) and other similar polyesters. Such polyesters are halogen-free, recyclable, environmentally safe and readily available at low costs and is therefore considered as a good alternate to traditional shrink materials. However, such polyesters possess very low shrinkage properties, not more than 30% and therefore cannot meet the requirements of practical applications. Further, these being linear polymer having low molecular weight possess low melting strength. Accordingly, pure form of such polyesters are not considered as suitable for mass production of shrink films and therefore are generally modified using various methods so as to improve their melt strength and other desired properties such as tensile strength, shrinkage ratio, and the like.

In some instances, a PET based shrink film comprising a composition of PET added with neopentyl glycol was prepared. Such films possess high shrinkage properties. However, the heat-shrinkable polyester film prepared in these patents, possesses low melt strength, and therefore, often cannot meet the needs of the secondary blown film processing conditions.

Various low density polyethylene (LDPE) films have also been available in market recently. However such LDPE films do not possess sufficient strength and puncture resistance. In order to overcome the lower strength of LDPE films, films containing a blend of both LDPE and linear low density polyethylene (LLDPE) have also been used commercially. An LDPE+LLDPE film generally has increased strength relative to an LDPE film, but often have reduced clarity and shrink.

To overcome the above mentioned issues various high strength alternates comprising various modified polyesters such as PETG (1,4-cyclohexanedimethanol modified poly(ethylene terephthalate)) have also been suggested for shrink film. While, these films offer excellent shrink properties and rather good tensile strength, these films are costly and not much conducive to recycling. Therefore such modified polyester based films are also not recommended.

Accordingly, there is a need in the art for an improved heat shrink polyester films which while being cost effective and environmentally non-toxic also inherits expected shrinkage properties, melt strength, mechanical/tensile strength, along with other desirable properties for a heat shrinking packaging films.

### SUMMARY OF THE INVENTION

In one aspect of the present disclosure, a method for preparation of a heat shrinking polyester film is provided. The method includes obtaining a polyester film made from a modified composition of a polyester. The composition of polyester include one or more polyester selected from but not limited to group consisting of terephthalic acid (PET), naphthalenedicarboxylic acid (PEN), 1,4-cyclohexane-dicarboxylic acid, Polybutylene terephthalate (PBT), Polytrimethylene terephthalate (PTT) and isophthalic acid. The composition further includes an amount of Maleic anhydride as a cross linking agent, and optionally an amount of glycol. The method further includes thermally stretching the obtained polyester film in a stretching direction under a predetermined reduced temperature. Thereafter, the polyester film is cooled thereby locking the shrink properties within the polyester film.

Preferably, the polyester added within the modified polyester composition is terephthalic acid (PET).

Further preferably, the glycol added within the modified polyester composition is ethylene glycol.

Alternatively, the glycol added within the modified polyester composition is a combination of ethylene glycol and one or more glycol selected from but not limited to but not limited to ethylene glycol, diethylene glycol, polyethylene glycol, and polyols such as butanediol and the like

Generally, the polyester film is obtained using from a extrusion process of the modified polyester composition at a temperature ranging between 170° C. and 290° C. Potentially, the polyester film may be thermally stretched in one or more stretching direction at a temperature ranging between 50° C. and 100° C. and preferably between 60° C. and 90° C.

Further Potentially, the shrink polyester film exhibits a heat shrinkage ratio greater than 20% and preferably greater than 50% in the stretching direction.

Preferably, the stretched film body has a film thickness ranging from 0.01 mm to 1.0 mm and preferably ranging between 0.05 mm-0.5 mm.

Alternatively. the stretched film body may be of any thickness appropriate for the application thereof.

Generally, the polyester material has a glass transition temperature generally ranging from 30° C. to 85° C. and preferably ranging from about 50° C. to about 65° C. Further, the modified polyester material has a melting point ranging from 175° C. to 290° C.

Optionally, the modified Polyester composition contains 1 to 40 mole % of said cross linking agent maleic anhydride based on one mole of polyester material.

Further optionally, the modified Polyester composition contains 1 to 40 mole % of said glycol based on one mole of polyester material.

In another aspect of the present invention, the disclosure provides a heat shrink polyester film made of a composition of modified polyester including one or more polyesters, an amount of maleic anhydride as a cross-linking agent; and optionally an amount of a glycol.

Preferably, the polyester added within the modified polyester composition is selected from but not limited to group consisting of terephthalic acid (PET), naphthalenedicarboxylic acid (PEN), 1,4-cyclohexane-dicarboxylic acid, Polybutylene terephthalate (PBT), Polytrimethylene terephthalate (PTT) and isophthalic acid.

Further preferably, the polyester added within the modified polyester composition is terephthalic acid (PET).

Additionally, the glycol added within the modified polyester composition is ethylene glycol. The details of one or more implementations are set forth in the accompanying drawings and the description below. Other aspects, features and advantages of the subject matter disclosed herein will be apparent from the description, the drawings, and the claims.

### BRIEF DESCRIPTION OF THE DRAWINGS

FIG. 1 illustrates a flowchart depicting a method for preparing a heat shrinking polyester film in accordance with one embodiment of the present disclosure;

FIG. 2 illustrates a flowchart depicting a method for obtaining a modified polyester film in accordance with one embodiment of the present disclosure;

### DETAILED DESCRIPTION OF THE INVENTION

As required, an exemplary-only embodiment of the present application is disclosed herein; however, it is to be understood that the disclosed embodiment is merely exemplary of the present disclosure, which may be embodied in various and/or alternative forms. Specific process or methodological details disclosed herein are not to be interpreted as limiting, but merely as a basis for the claims and as a representative basis for teaching one skilled in the art to variously employ the present disclosure in virtually any appropriately detailed processes.

Aspects, advantages and/or other features of the exemplary embodiment of the disclosure will become apparent in view of the following detailed description, which discloses various non-limiting embodiments of the invention. In describing exemplary embodiments, specific terminology is employed for the sake of clarity. However, the embodiments are not intended to be limited to this specific terminology. It is to be understood that each specific portion includes all technical equivalents that operate in a similar manner to accomplish a similar purpose.

Exemplary embodiments may be adapted for many different purposes and are not intended to be limited to the specific exemplary purposes set forth herein. Those skilled in the art would be able to adapt the exemplary-only embodiment of the present disclosure, depending for example, on the intended use of adapted embodiment. Moreover, examples and limitations related therewith brought herein below are intended to be illustrative and not exclusive. Other limitations of the related art will become apparent to those of skill in the art upon a reading of the following specification and a study of the related figures. The invention will be more clearly understood from the following description of the methods thereof, given by way of example only with reference to the accompanying drawings. In the descriptions that follow, like numerals represent like elements in all figures. For example, where the numeral (2) is used to refer to a particular element in one figure, the numeral (2) appearing in any other figure refers to the same element.

The present application discloses a method for preparing heat shrinking film made from a composition of a modified polyester preferably, selected as Tetraphalic acid (PET). The heat shrink film prepared using the method disclosed in the present invention has excellent melting properties, tensile strength, and has a desired shrink property and is completely recyclable. As one of ordinary skill in the art would appreciate, variations of the invention may be applied to other possible uses such as for various packaging application in various industries such as including food, medicinal, and other possible industries. Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, each numerical parameter should at least be construed in light of the number of reported significant digits and by applying ordinary rounding techniques. Further, the ranges stated in this disclosure and the claims are intended to include the entire range specifically and not just the endpoint(s). For example, a range stated to be 0 to 10 is intended to disclose all whole numbers between 0 and 10 such as, for example 1, 2, 3, 4, etc., all fractional numbers between 0 and 10, for example 1.5, 2.3, 4.57, 6.1113, etc., and the endpoints 0 and 10.

Moreover, it should be understood that embodiments of the present invention may be applied in combination with various other packaging solutions for various possible applications. It must also be noted that, as used in this specification and the appended claims, the singular forms “a,” “an” and “the” include plural referents unless the context clearly dictates otherwise. Thus, for example, the term “a polyester” is intended to mean a single polyester or a combination of polyesters. Further, the term “controlled”, “controlling”, “slowly used interchangeably herein to refer to the manipulation of a method or components of a composition to achieve a desired characteristic or keep said desired characteristic within certain bounds defined by a user. By way of example only, a controlled heating refers to a heating mechanism in which the temperature and conditions of heating are kept within user-defined limits. Similarly, the term “right-choice”, “suitable”, “appropriate” used interchangeably herein to refer to the manipulation of a method or components of a composition to achieve a desired characteristic or keep said desired characteristic within certain bounds defined by a user.

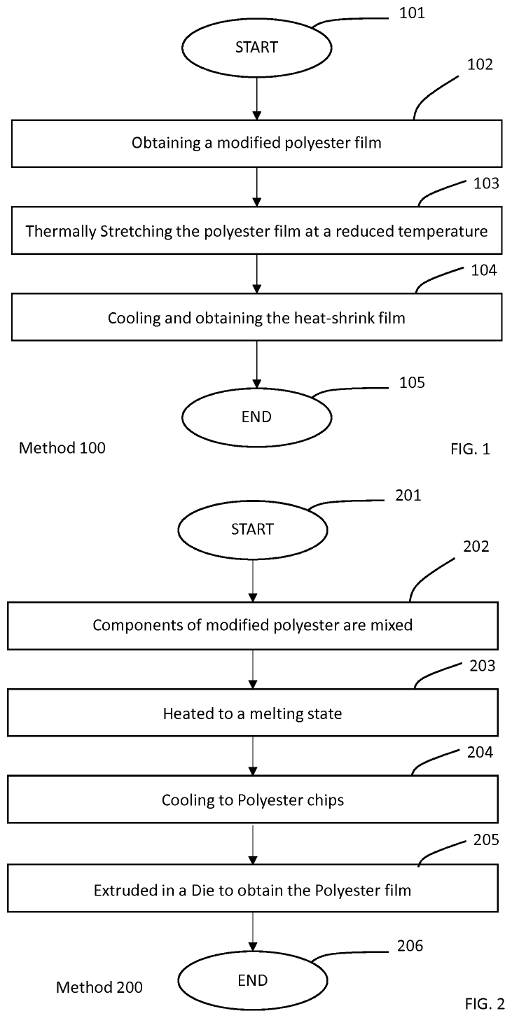

The present invention discloses a method 100 for preparing a heat shrink film, according to an illustrative embodiment as depicted in FIG. 1. The heat shrink polyester film may be described as a polyester film that shrinks when heated above a certain temperature, and serves a role generally as packaging film, commonly used for the packaging of various food, medicines, and the like. The heat shrink polyester film of the current disclosure is a shrink film that inherits high desired shrink properties, desired glossiness and adequate tensile strength while being of a very smooth and glossy finish so as to suitably replace currently known PVC shrink films and all known LDPE shrink films.

As illustrated in FIG. 1, the method 100 includes a number of steps, however, sequence of the method steps disclosed hereinafter are exemplary for the sake of understanding the invention for persons skilled in the art. The method 100 starts at step 101 and proceeds to step 102 where a film of modified polyester is obtained. The polyester film is a film made of a modified composition comprising one or more polyesters and/co-polyester raw materials modified using maleic anhydride as a cross-linking agent. The polyester composition used for the preparation of the polyester film may further optionally include one or more glycols. Suitable glycols include ethylene glycol, diethylene glycol, polyethylene glycol, and polyols such as butanediol and the like. Mixtures of two or more of the foregoing are also suitable.

For the purposes of the invention, polyester raw materials are formulations in which the predominant part, i.e. at least 80% by weight, preferably at least 90% by weight, is composed of a polymer selected from the class consisting of polyethylene terephthalate (PET), polyethylene naphthalate (PEN), poly-1,4-dicyclohexanedimethylene terephthalate (PCT), Polybutylene terephthalate (PBT), Polytrimethylene terephthalate (PTT), polyethylene naphthalate bibenzoate (PENBB) or mixtures of these polymer. Preference is given to polyester raw materials built up essentially from ethylene terephthalate units and/or up to 40 mol % of cross-linking agent and the glycol, wherein the amount of glycol component and/or the cross-linking component may vary.

Further, preferably, In an embodiment of the present invention, The heat-shrinkable, polyester film is a PET shrink film made of a composition comprising at least about 80 wt % PET, more preferably at least about 90 wt % PET. The PET can be a homopolymer or copolymer of PET. A PET homopolymer is intended to mean a polymer substantially derived from the polymerization of ethylene glycol with terephthalic acid, or alternatively, derived from the ester forming equivalents thereof (e.g., any reactants which can be polymerized to ultimately provide a polymer of polyethylene terephthalate). A copolymer of PET is intended to mean any polymer comprising (or derived from) at least about 50 mole percent ethylene terephthalate, and the remainder of the polymer being derived from monomers other than terephthalic acid and ethylene glycol (or their ester forming equivalents).

Generally, the PET material has a melting point ranging from 170° C. to 250° C. Modified polyesters having a glass transition temperature Tg that is too low can be sticky at room temperature, which is undesirable for most film applications. Such polyesters may be hard to polymerize, resulting in a sticky, unusable or less effective product of polymerization. Such polyesters can also be vulnerable to unintended shrinkage during high temperatures encountered during storage or transportation, thus rendering such films untenable for many end uses and customers. Low amounts of such diols may be used to minimize these problems and maintain a higher Tg. However, in such cases the levels that are viable may be insufficient to produce desired shrink properties. Preferably, the PET material has a glass transition temperature Tg ranging from 30° C. to 85° C., more preferably, from 60° C. to 80° C., and most preferably, from 50° C. to 65° C.

The polyester films may be produced by any known processes from abovementioned raw materials or by combining abovementioned polyester raw materials with other raw materials or with conventional additives in usual amounts of from 0.1 to not more than 10% by weight.

In a preferred embodiment, the polyester film may be formed by an extrusion process as illustrated in FIG. 2. The method 200 starts at step 201 and proceeds to step 202 where polyester raw material, cross-linking agent maleic anhydride and optionally, the glycol is mixed together and heated to a melting state at a temperature generally ranging between 175° C. to 290° C. at step 203. Thereafter, the method 200 proceeds to step 204 where the composition is cooled to obtain polyester chips of the dried composition. Thereafter, the polyester chips are extruded through a slot die and, in the form of a substantially amorphous prefilm, quenched on a chill roll to obtain the desired polyester film at step 205. Generally, the modified polyester composition contains 1 to 40 mole % of said cross linking agent based on one mole of polyester material. Further, the modified polyester composition contains 1 to 40 mole % of said cross linking agent based on one mole of polyester material. However, any suitable amount as deemed appropriate by a person skilled in the art may be added within the composition.

In addition, the polyester composition may further comprise one or more of the following: antioxidants, melt strength enhancers, branching agents (e.g., glycerol, trimellitic acid and anhydride), chain extenders, flame retardants, fillers, acid scavengers, dyes, colorants, pigments, antiblocking agents, flow enhancers, impact modifiers, antistatic agents, processing aids, mold release additives, plasticizers, slips, stabilizers, waxes, UV absorbers, optical brighteners, lubricants, pinning additives, foaming agents, antistats, nucleators, glass beads, metal spheres, ceramic beads, carbon black, cross-linked polystyrene beads, and the like. Colorants, sometimes referred to as toners, may be added to impart a desired neutral hue and/or brightness to the polyester film. Preferably, the polyester compositions may comprise 0 to about 10 weight percent of one or more processing aids to alter the surface properties of the composition and/or to enhance flow. Representative examples of processing aids include calcium carbonate, talc, clay, mica, zeolites, wollastonite, kaolin, diatomaceous earth, TiO2, NH4Cl, silica, calcium oxide, sodium sulfate, and calcium phosphate. Use of titanium dioxide and other pigments or dyes, might be included, for example, to control whiteness of the film or to make a colored film.

Additionally, the polyester composition may further include a chain branching agent into the polymerization system to increase the degree of branches of the polyester, the melt strength of the polymer can be considerably enhanced, thereby rendering the polyester suitable for stretching using double-bubble film blowing techniques, and the like. Preferably, the chain branching agent is selected from the group consisting of 1,1,1,-Tris(hydroxylmethyl)propane, 1,1,1,-Tris(hydroxylmethyl)propane alkoxylate, pentaerythritol, pentaerythritol alkoxylate, Di-pentaerythritol, Di-pentaerythritol alkoxylate, Tri-pentaerythritol, glycerol, and combinations thereof. Preferably, the modified PET composition contains 0.01 to 2 mole % of the chain branching agent based on one mole of Polyester, and more preferably contains 0.05 to 1 mole % of the chain branching agent based on one mole of polyester.

Looping back to method 100, the method proceeds to step 103 where the obtained polyester film is thermally stretched in a stretching direction under a temperature ranging from 50° C. to 100° C. and preferably ranging from 60° C. to 90° C., such that the ratio of the film thickness of the polyester film after stretching to that of the polyester film before stretching ranges from 0.2 to 0.95. Preferably, the thermally stretched polyester film body has a film thickness ranging from 0.01 mm to 1.0 mm and more preferably, the polyester film body has a film thickness ranging from 0.05 mm to 0.5 mm.

The thermal preferred embodiment, the thermal stretching of the polyester film is performed by double bubble blown film extrusion techniques and the polyester film stretching operation is conducted along two perpendicular directions, i.e., longitudinal direction as well as transverse direction. The heat shrinking polyester film may have a free shrink at 85° C. in at least one direction (e.g., the longitudinal direction or the transverse direction) and/or in both the longitudinal and transverse directions of at least about, and/or at most about, any of the following: 10%, 15%, 25%, 30%, 40%, 45%, 50%, 55%, 60%, 70%, and 80%.

In instances, where the PET based film is formed, the stretching temperature of the heat shrinking film is generally 10 to 15° C. higher than the glass transition temperature of the PET material, and the temperature for shrinking the stretched PET film is 10 to 15° C. higher than the stretching temperature. Hence, the stretching temperature for stretching the PET film preferably ranges from 45° C. to 100° C., and more preferably, from 65° C. to 85° C., and the temperature for shrinking the stretched PET film preferably ranges from 65 to 115° C., and more preferably, from 85 to 100° C. Additionally, the heat-shrinkage ratio of the heat-shrinkable PET film of this invention can be adjusted by adjusting the modified PET composition, the stretching extent, and the stretching temperature based on the actual requirements.

Preferably, the thermally stretched film body exhibits a heat shrinkage ratio greater than 20% in a stretching direction under a temperature ranging from 50° C. to 140° C. More preferably, the thermally stretched film body exhibits a heat shrinkage ratio greater than 50% in the stretching direction under a temperature ranging from 50° to 140° C.

The method then proceeds to step 104 where the polyester film is cooled so as to lock the shrink properties within the film and wound up. The process described here for producing heat shrink polyester films is applicable not only to polyester but also to other thermoplastic polymers. It is understood that the present invention also encompasses various modifications to control and improve shrink properties as well known to those skilled in the art. For example, to improve shrinkage at lower temperatures, a polyester or polyester monomer, or alternate polymer with a low softening point (e.g., diethylene glycol or butanediol) may be incorporated to lower the overall Tg of the polyester film. Soft segments based on polytetramethylene glycol, PEG, and similar monomers, may be added to flatten the shrink curve, lower the shrink onset, control the rate of shrinkage or improve tear properties. The shrink properties are dependent on the stretching conditions which may be modified as appropriate to provide variations in properties such as, for example, controlled shrink force, shrink force ratios in each direction, controlled shrinkage, and property retention after shrinkage.

### Example

### Preparation of Heat Shrink PET Film

### Step 1: Esterification

Mixing purified terephthalic acid, ethylene glycol, and Maleic anhydride at a set molar ratio=1:0.03:0.15:0.15 in a slurry mixing tank with stirring
Thereafter adding the slurry from the slurry feed tank through an injection nozzle into the esterification reactor.
Obtain a homogeneous mixed composition by an action of an agitator in the slurry.

### Step 2: Condensation of the Mixed Polyester Composition

The collected PET composition after esterification condensed at a temperature 280˜290° C., pressure 16-25 mm Hg in prepolymer kettle to obtain PET polyester chips

### Step 3: Granulating the Polyester Chips

The obtained polyester chips were granulated in small sections of PET having a Tg 70° C.

### Step 4: Preparation of Heat-Shrinkable Polyester Film

The obtained PET co-polyester sections were added to an extruder at a set temperature 240-285° C. and melt-extruded through a preformed die to obtain a PET polyester film.

### Step 5: Stretched Locking the Film

Thereafter the shrink film was trimmed to a 1650 mm, the thickness of the film at 0.1 m heated to 78° C. and stretched 4.5 times transversely way, heat-shrinkable PET film having a thickness of 0.05 mm. After testing to obtain the shrinkage rate of 55%
Result:—The obtained PET shrink film thus produced possesses a shrink rate of 55%.

### INDUSTRIAL APPLICABILITY

The present disclosure relates to a method 100 for preparing a heat shrinking polyester film made of a specifically modified composition of one or more polyester, specifically made of a modified PET, using a maleic anhydride as a cross-linking agent. The method is very simple, cost effective, and requires equipment improvements on the original polyester film production equipment and facilities for the preparation of the films. Accordingly, the manufacturing process is stable and reliable and easily usable for mass production of the shrink foils at industrial scale.

As is known in the art, a heat-shrinkable film shrinks upon the application of heat while the film is in an unrestrained state. If the film is restrained from shrinking to some extent—for example by a packaged product around which the film shrinks—then the tension of the heat-shrinkable film increases upon the application of heat. Accordingly, a heat-shrinkable film that has been exposed to heat so that at least a portion of the film is either reduced in size (unrestrained) or under increased tension (restrained) is considered a heat-shrunk (i.e., heat-contracted) film.

The heat shrink film of present disclosure is of very high shrink quality while inheriting excellent appearance, glossiness tensile strength along with melting properties. These heat shrink foils are well suited to replace all currently known PVC as well as LDPE shrink films already known in the art.

The PET heat shrink foil of the current disclosure are able to achieve shrink properties even at low temperature while providing relatively high tensional resistance. Generally, the PET polyester shrink film has a 50%-80% of high, medium and low shrinkage, and can meet the needs of different shrinkage of the market. Films having shrinkage of less than about 50% can be used in some of the same markets as other low shrink, specialty polyester films. Films having shrinkage of more than about 50% are preferred for traditional shrink film markets, including markets for shrinkable packaging labels. Preferred shrinkages ranges in a main direction for such embodiments range from about 50 to about 80% (considered full return), alternately about 60 to about 80%, alternately about 70 to about 80%, alternately about 75% to about 80%.

Preferred films of the present invention are believed to have good impact resistance properties, due to increased elongation-to-break properties resulting from high amorphousness. Further, the film may exhibit a shrink tension at 85° C. in at least one direction, and/or in at least both of the machine and transverse directions, of at least about, and/or at most about, any of the following: 50 psi, 75 psi, 100 psi, 125 psi, 150 psi, 175 psi, 200 psi, 225 psi, 250 psi, 275 psi, 300 psi, 325 psi, 350 psi, 400 psi, 450 psi, 500 psi, 550 psi, and 600 psi. The film may have unequal shrink tension in both directions, that is differing shrink tension in the machine and transverse directions. The film may not have a shrink tension in one or both directions.

Further, the PET heat shrink foil of the current disclosure being made of a composition which is environmentally very safe also being completely recyclable is therefore, well suited to be utilized for various purposes such as including but not limited to packaging industry for packaging of various food, medicine, disinfection tableware, stationery, gifts, prints, metal plastic products, phone machines, electronic appliances and other products, packaging, especially in the irregular shape of goods or merchandise modular (cluster) packaging.

Further, the shrink films of current disclosure are able to be used for packaging of various moisture and dust product. Since these shrink films are able to be pigmented, printed, therefore may act in some instances as transparent display and other instances where printing and pigmentation is required so as to increase the attractiveness of product appearance.

Additionally, the shrink films of the current disclosure are usable and accommodated to replace of all kinds of carton packaging not only to save costs, but also in line with the trend of shrink film packaging (bag) and can can be processed into: pocket, arc-shaped bag, trapezoid bag, three-dimensional bags shaped bag, and the like. Further, the shrink films are well durable under normal packaging, transport and storage conditions.

While the current disclosure have been described for the application of the shrink film within the packaging industry, the current invention may be used for various other purposes within the food/transport/medical and various other industries.

Referring to FIGS. 1 and 2, methodology in accordance with a preferred embodiment of the claimed subject matter is illustrated. While, for purposes of simplicity of explanation, the methodology is shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter.

As will be readily apparent to those skilled in the art, the present invention may easily be produced in other specific forms without departing from its essential characteristics. The present embodiments is, therefore, to be considered as merely illustrative and not restrictive, the scope of the invention being indicated by the claims rather than the foregoing description, and all changes which come within therefore intended to be embraced therein. Many variations, modifications, additions, and improvements are possible. More generally, embodiments in accordance with the present disclosure have been described in the context of preferred embodiments. Functionalities may be separated or combined in procedures differently in various embodiments of the disclosure or described with different terminology. These and other variations, modifications, additions, and improvements may fall within the scope of the disclosure as defined in the appended claims.

1. A heat-shrinkable polyester film comprising a thermally stretched film body, the film made from a modified polyester composition comprising:
one or more polyesters chosen from polyethylene terephthalate (PET), polyethylene naphthalate (PEN), poly-1,4-dicyclohexanedimethylene terephthalate (PCT), Polybutylene terephthalate (PBT), Polytrimethylene terephthalate (PTT), polyethylene naphthalate bibenzoate (PENBB) and mixtures thereof;
an amount of maleic anhydride as a cross-linking agent; and
optionally an amount of a glycol.

2. The heat-shrinkable polyester film of claim 1, wherein the said polyester includes terephthalic acid (PET).

3. The heat-shrinkable polyester film of claim 1, wherein said thermally stretched film body exhibits a heat shrinkage ratio greater than 20% in a stretching direction under a temperature ranging from 50° C. to 140° C.

4. The heat-shrinkable polyester film of claim 3, wherein said thermally stretched film body exhibits a heat shrinkage ratio greater than 50% in the stretching direction under a temperature ranging from 60° to 140° C.

5. The heat-shrinkable polyester film of claim 1, wherein said thermally stretched film body has a film thickness ranging from 0.01 mm to 1.0 mm.

6. The heat-shrinkable polyester film of claim 1, wherein the polyester material has a glass transition temperature that is sufficiently high to render the polymer film resistant to shrinkage at temperatures normally experienced during shipping.

7. The heat-shrinkable polyester film of claim 6, wherein said Polyester material has a glass transition temperature generally ranging from 30° C. to 85° C.

8. The heat-shrinkable polyester film of claim 1, wherein said polyester material has a melting point ranging from 175° C. to 290° C.

9. The heat-shrinkable polyester film of claim 1, wherein said modified Polyester composition contains 1 to 40 mole % of said cross linking agent based on one mole of polyester material.

10. The heat-shrinkable polyester film of claim 1, wherein said modified Polyester composition contains 1 to 40 mole % of said glycol based on one mole of polyester material.

11. The heat-shrinkable polyester film of claim 1, wherein the glycol includes ethylene glycol.

12. The heat-shrinkable polyester film of claim 1, wherein the glycol includes ethylene glycol and an additional glycol chosen from ethylene glycol, diethylene glycol, polyethylene glycol, and a polyol.

13. The heat-shrinkable PET polyester film of claim 1, wherein said modified Polyester composition further comprises one or more chain branching agents chosen from 1,1,1,-Tris(hydroxylmethyl)propane, 1,1,1,-Tris(hydroxylmethyl)propane alkoxylate, pentaerythritol, pentaerythritol alkoxylate, Di-pentaerythritol, Di-pentaerythritol alkoxylate, Tri-pentaerythritol, glycerol, and combinations thereof.

14. A method for making a heat-shrinkable Polyester film, comprising:
(a) forming a polyester film of a modified Polyester composition that comprises one or more polyester formed by polycondensation of a glycol and a carboxylic acid chosen from terephthalic acid, naphthalenedicarboxylic acid, 1,4-cyclohexane-dicarboxylic acid and isophthalic acid, and using Maleic anhydride as a cross linking agent;
(b) thermally stretching the PET film in a stretching direction under a temperature ranging from 50° C. to 130° C.; and
(c) cooling the thermally stretched PET film.

15. The method of claim 14, wherein forming the polyester film comprises the step of extruding a modified polyester polymerized from monomers composition including a dicarboxylic acid and a glycol.

16. The method of claim 15, further including the step of applying heat to the polymer film ranging from 175° C. to 290° C. during manufacture.

17. A heat-shrinkable polyester film comprising a PET film made of a modified PET composition that comprises terephthalic acid, maleic anhydride and optionally, ethylene glycol.

18. The heat-shrinkable polyester film of claim 17, wherein said PET film body exhibits a heat shrinkage ratio greater than 20% in a stretching direction under a temperature ranging from 50° C. to 140° C.

19. The heat-shrinkable polyester film of claim 5, wherein said thermally stretched film body has a film thickness ranging between 0.05 mm-0.5 mm.

20. The method of claim 14, wherein the temperature ranges from 60° C. to 90° C.
